(19) United States
(12) Patent Application Publication
(10) Pub. No.: US 2016/0244641 A1
(43) Pub. Date: Aug. 25, 2016

(54) SYSTEM AND METHOD FOR MAKING A TEXTURED FILM

(71) Applicant: 3M INNOVATIVE PROPERTIES COMPANY, Saint Paul, MN (US)

(72) Inventors: John P. Baetzold, North St. Paul, MN (US); Mitchell A. F. Johnson, Maplewood, MN (US); Steven J. McMan, Stillwater, MN (US); Frank T. Sher, St. Paul, MN (US); Robert A. Yapel, Oakdale, MN (US); Patrick J. Yeshe, Woodbury, MN (US)

(73) Assignee: 3M INNOVATIVE PROPERTIES COMPANY, St. Paul, MN (US)

(21) Appl. No.: 15/030,918

(22) PCT Filed: Oct. 9, 2014
(86) PCT No.: PCT/US2014/059797

§ 371 Date: Apr. 21, 2016

Related U.S. Application Data
(60) Provisional application No. 61/894,609, filed on Oct. 23, 2013.

(51) Int. Cl. C09J 7/02

(52) U.S. Cl. CPC C09J 7/0232; C09J 2433/005; C09J 2461/00; C09J 2201/606; C09J 2427/006; C09J 2205/10

(57) ABSTRACT

A system and a method for making a web having a complex topography. A substrate having coatable material is contacted by a face-side roller having grooves set into the major surface thereof, the coatable material is then split between the face side roller and the substrate, resulting in a textured surface having a first area associated with the splitting from the major surface, and a second area resulting from splitting associated with areas of the face-side roller having grooves. Raised ridge features produced from the splitting step interconnect portions within the first area, and portions within the second area, and in between the first and second area.

### BACKGROUND

Pressure sensitive adhesives are useful for the joining of two materials. The interfaces between the adhesive and the materials are vital to the performance of the joined materials. The loss of adhesion at either interface can doom the usage of the materials.

One example of an adhesion interface requiring peak performance is a durable film displaying image graphics adhered to substrates, where the film is a backing material upon which an adhesive layer is added for adhesion to the substrate. Adhesion of a large image graphic film to substrates encounters the problem of entrapped air between the film and the substrate. Anyone who has ever attempted to hang wallpaper can appreciate the frustration that can arise when entrapped air beneath an adhesive-backed film cannot be removed easily. Some solutions to this problem are to remove and reapply the film or to perforate the film to release the entrapped air. Multiple attempts to adhere the same film to a substrate can compromise the pressure sensitive adhesive or increase the probability of uneven or misaligned film on the substrate. Perforating a film mars its appearance. The removal of air bubbles is also labor intensive.

Another solution is to introduce structural air egress features into the adhesive layer. One way to do this is to form the adhesive layer with a continuous network of recessed micro-channels that facilitate air egress during film installation. U.S. Pat. No. 5,897,930, “Multiple Embossed Webs” discusses an embossed release liner having a network of ridges. An adhesive layer may be applied to the embossed side of the release liner. Then the adhesive side of the adhesive-coated liner may be laminated to, for example, a graphic film. The release liner acts as a mold to introduce a network of micro-channels (corresponding to the ridges) into the adhesive layer. The micro-channels facilitate air egress during film installation.

### SUMMARY

A system for providing a web, such as a release liner, that has a textured surface characterized by a network of micro-ridges. When a formable material, such as a pressure sensitive adhesive layer, is brought in contact with the textured surface of the web, the textured surface acts as a mold and the pressure sensitive adhesive layer is formed around the textured surface, to introduce a network of micro-channels corresponding in size and dimension to the micro-ridges of the liner.

The liner web is made by a splitting process that brings the surface of a roller in contact with a viscous releasable, coatable material that has already been applied to the film. The wetted roller surface rotates away from the film in a splitting step which introduces a chaotic topographical structure into the viscous releasable material. The surface of the roller may include topographical roll features, such as inset grooves comprising repeating stripes, squares, or diamonds, or a matrix of lines, which depending on the viscosity of the releasable material, will express themselves to some degree in the viscous releasable material after the splitting step. The resultant liner film includes a first aspect resulting from the splitting step associated with areas of the face-side roller not having features, and a second aspect resulting from the splitting step associated with areas of the face-side roller having features. Together, in some embodiments, these first aspect and second aspect features combine to provide an ensuing pattern in the coatable material that may make it suitable for certain applications, such as a structured release liner that will act as a mold for a further adhesive layer, thereby endowing the adhesive layer with structure, in negative, of the surface topography of the release liner. In some applications, this adhesive layer may interface with a further graphic film (on the side not in contact with the release liner). The graphic film/adhesive layer may be separated from the structured release liner, then applied. The structure endowed in the adhesive layer may facilitate air egress while installing the graphic film.

In one embodiment, a method of producing a web with a complex topography is described, the method comprising applying a first coatable material to a first major surface of a substrate; changing the viscosity of the first coatable material from a first viscosity to a second viscosity to form a second coatable material; contacting the second coatable material on the substrate to a face-side roller having a first major surface and a plurality of roll features set into the first major surface of the face-side roller; splitting the second coatable material between the substrate and the face-side roller, to impart a resultant texture in the second coatable material on the substrate, wherein the resultant texture comprises a first area associated with splitting between the first major surface of the face-side roller and the substrate, and a second area resulting from splitting between an area on the face side roller associated with at least one of the roll features and the substrate, and wherein the resultant texture comprises an interconnected network of raised ridge features within at least the second area; and, hardening the textured second coatable material to produce the web with an ensuant textured surface. For the purposes of this disclosure, a film is a type of a web.

In another embodiment, a web is described, having a complex topography, produced by the method comprising applying a first coatable material to a first major surface of a substrate; changing the viscosity of the first coatable material from a first viscosity to a second viscosity to form a second coatable material; contacting the second coatable material on the substrate to a face-side roller having a first major surface and a plurality of roll features set into the first major surface of the face-side roller; splitting the second coatable material between the substrate and the face-side roller, to impart a resultant texture in the second coatable material on the substrate, wherein the resultant texture comprises a first area associated with splitting between the first major surface of the face-side roller and the substrate, and a second area resulting from splitting between an area on the face side roller associated with at least one of the roll features and the substrate, and wherein the resultant texture comprises an interconnected network of raised ridge features within at least the second area; and, hardening the textured second coatable material to produce the web with an ensuant textured surface.

In a further embodiment, a system for producing a web having a complex topography is described, the system comprising a first station that applies a first coatable material to a first major surface of a substrate; a second station that changes the viscosity of the first coatable material from a first viscosity to a second viscosity to form a second coatable material; a third station that contacts the second coatable material on the substrate to a face-side roller having a first major surface and a plurality of roll features set into the first major surface of the face-side roller, and splits the second coatable material between the substrate and the face-side roller, to impart a resultant texture in the second coatable material on the substrate, wherein the resultant texture comprises a first area associated with splitting between the first major surface of the face-side roller and the substrate, and a second area resulting from splitting between an area on the face side roller associated with at least one of the roll features and the substrate, and wherein the resultant texture comprises an interconnected network of raised ridge features within at least the second area; and, a fourth station for hardening the textured second coatable material to produce the web with an ensuant textured surface.

These and other embodiments are further described herein.

### BRIEF DESCRIPTION OF THE DRAWINGS

In describing embodiments of the invention, reference is made to the various Figures in which reference numerals indicate described features of the embodiments and like reference numerals indicate like structures, wherein:

FIG. 1 is a schematic view of a system for providing a textured finish on a film according an embodiment of the present invention;

FIG. 2 is a schematic view of a portion of a system for providing a textured finish on a film according a second embodiment of the present invention;

FIG. 3 is a schematic view of a portion of a system for providing a textured finish on a film according a third embodiment of the present invention;

FIG. 4A is a schematic view of a portion of a system for providing a textured finish on a film according a fourth embodiment of the present invention;

FIG. 4B is a drawing of splitting, in one embodiment;

FIG. 5A is an exemplary pattern for a face-side roller;

FIG. 5B is an exemplary pattern for a face-side roller;

FIG. 5C is an exemplary pattern for a face-side roller;

FIG. 5D is an exemplary pattern for a face-side roller;

FIG. 5E is an exemplary pattern for a face-side roller;

FIG. 5F is an exemplary pattern for a face-side roller;

FIG. 5G is an exemplary pattern for a face-side roller;

FIG. 5H is an exemplary pattern for a face-side roller;

FIG. 5I is an exemplary pattern for a face-side roller;

FIG. 5J is an exemplary pattern for a face-side roller;

FIG. 5K is an exemplary pattern for a face-side roller;

FIG. 6 is an image of an exemplary resultant texture;

FIG. 7A is a close up of a portion of the resultant textured shown in FIG. 6;

FIG. 7B is a graph showing the relative height of features shown in FIG. 7A.

FIG. 8 is an image of an exemplary resultant texture;

FIG. 9A is a close up of a portion of the resultant textured shown in FIG. 8;

FIG. 9B is a graph showing the relative height of features shown in FIG. 9A.

FIG. 10 is an image of an exemplary resultant texture;

FIG. 11A is a close up of a portion of the resultant textured shown in FIG. 10;

FIG. 11B is a graph showing the relative height of features shown in FIG. 11A; and,

FIG. 12 is a drawing of a cross-section of grooves associated with a face-side roller.

### DETAILED DESCRIPTION

Various terms used herein will be understood to be defined according to their ordinary meaning, as known by those skilled in the art. However, the following terms will be understood to have the meanings set forth herein.

The term “polymer” will be understood to include polymers, copolymers (e.g., polymers formed using two or more different monomers), oligomers and combinations thereof. Both block and random copolymers are included, unless indicated otherwise.

“Polymeric material” will be understood to include polymers, as defined above, and other organic or inorganic additives, such as, for example, release agents, rheology modifiers, antioxidants, stabilizers, antiozonants, plasticizers, dyes, UV absorbers, hindered amine light stabilizers (HALS), and pigments.

“Coatable material” means a non-solid (e.g., liquid or gel-like) material that is capable of being coated onto a surface.

“Face-side roller” means a roller or other instrument(s) that includes a surface that directly contacts the surface of a coatable material on a substrate, and upon splitting the coatable material between the surface and the substrate, imparts a chaotic finish to the surface of the coatable material. Although the described embodiments utilize an actual roller, a face-side roller may comprise any of a variety of configurations including without limitation a belt mounted on and driven by one or more drive rollers. The roller may have features, for example inset into, or outset from, the face (primary surface) of the roller. The features may take different patterns, as described further herein.

A release liner is releasable carrier web for a further web. A release liner may sometimes used in conjunction with a further web-type product, to lend characteristics to the further web-type product. For example, a textured release liner may be brought into contact with an adhesive layer applied to a further film, thereby acting as a mold and endowing the adhesive layer with a structure, in negative, to the structure of the release liner. A release liner may also protect a further web, or an adhesive layer of a further web. The release liner provides a release effect for certain types of material into which it is brought into contact, such as an adhesive or a mastic. The release liner may comprise a base substrate coated with a material that promotes the release effect. The material could be textured, as described further below. It could also comprise additionally further coatings that promote release. Examples of base materials for liners may include paper, polycoated paper, polycoated kraft paper, clay coated paper and the like, glassine paper, polyester, polyolefin, polystyrene, various types of non-woven, and metal-based foils.

The term “phr” refers to a unit of parts by weight of a component in a coating composition having 100 parts by weight of polymeric material.

Those skilled in the art will further appreciate the embodiments of the invention upon consideration of the remainder of the disclosure including the Detailed Description with the accompanying drawings and the appended claims.

This disclosure provides a system and a process for the manufacture of webs having complex topography on a surface of the web. In particular, the complex topography may comprise in one embodiment a network of ridges that are substantially interconnected. Such a topography may make the web suitable for use as a liner for a pressure sensitive adhesive-backed film, whereby the complex surface topography acts as a mold for the pressure sensitive adhesive, endowing the adhesive with a structure that may control the adhesion interface such as, for example a structure that may facilitate air egress during the application of films. The web may also be suitable as a liner for making films, including adhesive-backed films, a carrier for abrasive slurries used for later manufacturing, bump pads for flexible printed circuits, or a carrier for medicaments or cosmetics.

Such a topography may also be useful in some embodiments as decorative films, or films having a topography that promotes water drainage. Such a topography could be designed to approximate diamonds, squares, honeycomb, snake skin, etc. In such embodiments, the coatable material may be pigmented, which would in some embodiments provide for back lit tonal or saturated color special effect differences. Such tonal variations could also be part of a multi-step process, where different colors are built up on different splitting operations.

A first aspect of the complex topography arises primarily from the splitting of the coatable material between a coated substrate and the major surface of a face-side roller. This splitting step results in a disorganized texture of varying topography in the coatable material, extending substantially uniformly over the area of the split surface of the coatable material.

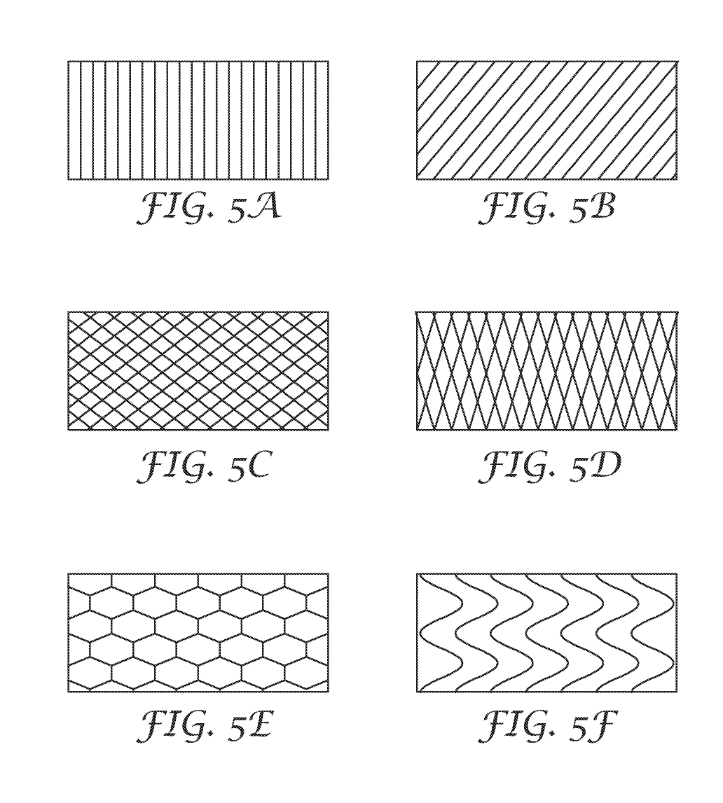

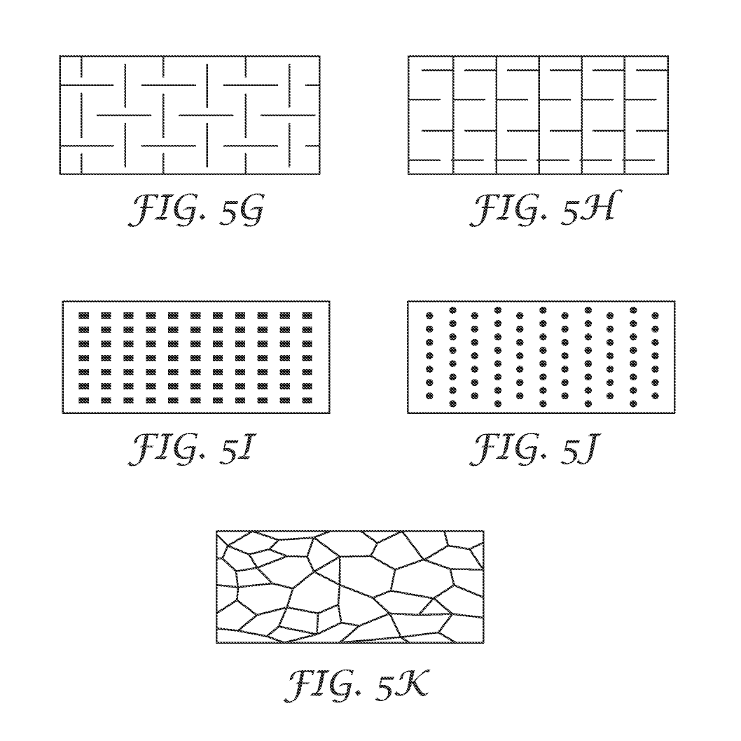

A second aspect of the complex topography arises as a function of splitting in areas of the face-side roller associated with an inset (or outset, as the case may be) feature set into the major surface of the face-side roller. These inset features may be referred to herein as grooves or channels for the purposes of describing some typical embodiments, though shapes of uniform dimension (for example, dots—see FIG. 5j) might not be considered a groove in the strict sense of the word. When the coatable material is brought into contact with the face side roller in anticipation of the splitting step, the coatable material is forced into the channels. After splitting the coatable material, the coatable material associated with the channels retains some aspect of the dimension and pattern of the grooves. The arrangement of the grooves can, in some embodiments, be in regular or irregular patterns. An irregular pattern of grooves, for example, might be without symmetry, without uniform shape, or without formal arrangement. The ensuing coatable material, after the splitting, is thus endowed with a topography or texture. In one embodiment, this topography or texture comprises a network of raised ridge features substantially interconnecting a first area associated with the splitting of the coatable material between the major surface of the face-side roller and the substrate, and substantially interconnecting a second area associated with the splitting of the coatable material between the feature-laden (that is, in some embodiments, groove containing) areas of the face-side roller and the substrate. In some embodiments, such splitting results in ridge-like structures that extend from the first area into the second area.

The interconnected network of raised ridge features associated with the second area correspond in position and dimension to the positioning and dimensions of the roll features. Such roll features in some embodiments comprise a repeating pattern set into the surface of a face-side roller. The degree to which the resultant ridges correspond to the size and orientation of the channels is a function of many process control variables, for example the viscosity of the coatable material, the time the coatable material is allowed to rest after the splitting but before curing, the degree to which the coatable material will tend to relax after the splitting step but before curing, and myriad other process variables that affect the curing of the coatable material. FIG. 5a-k show example patterns of features inset into the major surface of the face-side roller. FIG. 5a shows a series of repeating, linear, down-web features having a common pitch. FIG. 5b shows a series of repeating, linear, diagonal-web features having a common pitch. FIGS. 5c and 5d show a pattern of repeating diamond-shaped features. FIG. 5e shows a honeycomb-like pattern. FIG. 5f shows a repeating, serpentine-type pattern. FIG. 5g shows a cross-hatch type pattern. FIG. 5h shows trunk and spoke type pattern. FIG. 5i shows an array of repeating squares. FIG. 5j shows an array of repeating circular features. FIG. 5k shows a network of cells that having an ostensibly chaotic variation to their dimension. Such a network may reduce certain visual anomalies associated with the ensuing pattern, such as moiré. While specific embodiments are shown in FIGS. 5a-k, these are shown for purposes of illustration only and should not be interpreted as limiting. Any suitable combination of inset grooves could be used. This can include linear, wavy, polygons that include triangular, square, rectangular, diamond, honeycomb, a mix of adjacent, different polygons, etc. Also, the pattern of grooves may take any suitable pitch. The groove depth and cross-sectional profile may also be selected from any suitable combination. The groove depth should be selected such that the coatable material generally makes contact with all sides of the groove when the contacting of the face-side roller and the coatable material takes place.

The percentage area of the face side roller that is inset in some embodiments range from about 1% to about 85%, as determined by measuring the total open area of the face side roller, the open area being associated with grooves. In reference to FIG. 12, showing the profile of a set of grooves on a face-side roller (further discussed later), the groove area is about 13% of the total face-side roller surface area. In some embodiments, the lower range may be 1%, 2%, 3%, 4%, 5%, 6%, 7%, 8%, 9%, 10%, 11%, 12%, 13%, 14%, 15%, 16%, 17%, 18%, 19%, 20% and so on up to 85%, or ranges in between any of these numbers. In some preferred embodiment, the range is between about 3% and 50%, or in some embodiments 4% to 40%, or in some embodiments about 5% and 30%. The depth of grooves in some embodiments range from about 0.1 micrometer to about 200 micrometers, preferably from about 10 micrometers to about 100 micrometers, and most preferably from about 20 micrometers to about 60 micrometers. The particular depth of the grooves may be fine tuned based on the type of coatable material to be split and the desired characteristics of the resulting textured surface. The “sidewalls” of grooves inset in the face-side roller can be any shape desired, ranging from a constant radius of curvature to any polygonal shape of at least 2 surfaces. Nonlimiting examples of shapes in cross-section, include curved, rectangular, trapezoidal, triangular, bimodal, and the like. The width of grooves, as measured across the major surface of the face-side roller, can vary as needed. For example, in one exemplary embodiment the width of grooves are relatively uniform across the face-side roller. Precision of topographical formation of face-side roller can be achieved using a variety of machining techniques. The machine tool industry is capable of creating face-side roller tools with a wide range of possible groove patterns, using known techniques such as diamond engraving, laser engraving, sandblasting, chemical etching, and knurling.

Because the coatable material relaxes somewhat after the splitting step, and because the splitting step has a chaotic, uncontrolled element to it, the process described herein does not result in perfect correspondence between the roll features and the resultant, cured, coatable material, as a traditional embossing process would attempt to achieve. In other words, whereas a traditional embossing process would bring a formable material (as distinguished from a coatable) in contact with raised features of a pattern in an effort to achieve a high correspondence between the features of the embossing roll and the surface topography of the formable material, the splitting process described herein results in less correspondence between the roller features and the resultant patterns. Further, in traditional embossing, the materials to be brought in contact with an embossing roll are generally selected to not be coatable thus eliminating or minimizing anything like the splitting operation described herein, and with such elimination, removing or greatly limiting any chaotic pattern that would be introduced as part of such a splitting step.

The roll features may take the form of many different pattern types. In one embodiment the roll features comprise a diamond shaped network of grooves (that is, grooves recessed from the outer surface of the roller), which interface with the coatable material to endow it, after the splitting step, with raised ridges corresponding generally to the size and position of the grooves. After the coatable material has been cured it may be used as a liner, and a release agent (such as silicone) may be applied to its now textured surface, and a pressure sensitive adhesive then coated onto the liner. The coatable material may comprise a release component, such as a release agent, as part of its formulation. The coated release liner may then act as a mold for the pressure sensitive adhesive, endowing the pressure sensitive adhesive with a surface topography corresponding, in negative, to the variable topography of the cured coatable material. The other, non-liner interfacing side of the pressure sensitive adhesive may be laminated to a graphic film. The network of diamond-shaped patterns, coupled with the chaotic topography introduced from the splitting step, results in a graphic film having a structured adhesive layer with channels that may facilitate the egress of trapped air (i.e., bubbles) that may occur during installation of the graphic film.

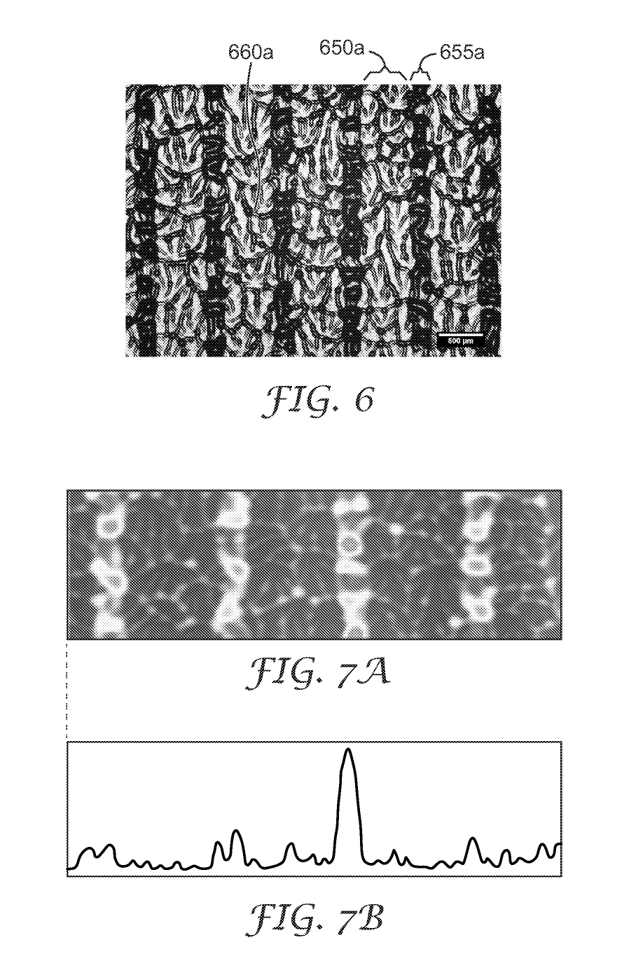

An exemplary ensuing textured surface is shown in FIG. 6, which is further described with respect to Example 1, below. The sample shown in FIG. 6 was made with a face side roller having inset features approximating the down-web channels shown with respect to FIG. 5a. The dimensions of these inset features in the face-side roller are shown in FIG. 12. The face-side roller had a first major surface, as well as roll features inset (or outset, as the case may be) from the first major surface at a repeat pitch of 0.77 mm. The cross sectional profile of the grooves was trapezoidal, with an opening of 100 microns, and a sidewall slope of 110 degrees, and a depth of 25 microns. When the coatable material is split between the face side roller and the substrate, the resultant texture endowed to the coatable material comprises a first area associated with the splitting between the first major surface of the face-side roller, as well as at least one second area associated with splitting between an area of the face side roller associated with the roll features and the substrate. An interconnected network of raised ridge features includes ridges that extend from the first area to the second area. First area 650a shows a resultant texture in a coatable material that corresponds to splitting between the major surface of the face-side roller and the substrate. The second area 655a is a texture corresponding to the splitting of the coatable material between the substrate and the face-side roller in an area of the face-side roller associated with a roll feature. Raised ridge feature 660a is one particular ridge that meanders through first area 650a with branches extending into and interconnecting topography 655a. FIG. 7a shows a portion of the topography seen in FIG. 6, and FIG. 7b shows the height of features associated with a cross section of the portion. The large spike shown in FIG. 7b corresponds to the second area. The second area is generally associated with higher ridge features than would occur in the absence of roll features. In certain embodiments, this has the effect of providing more pronounced ridges that tend to be associated with the pattern of the roll features. If the resultant coatable material, once hardened, may be used as a mold to structure an adhesive (or in other liner-type applications where a formable material is cast on a liner to endow the cast material with texture), the ridges will correspond in the structured adhesive to channels, and the second area will tend to provide more consistent paths of air egress.

The process for the manufacture of webs having complex topographies as described herein may start with a coated substrate, which is a coatable material on a substrate or backing. In some embodiments, the coated substrate may be prepared in advance and the previously prepared coated substrate placed into the manufacturing process ‘as is.’ In some embodiments, the coated substrate is manufactured as part of the overall manufacturing process in which a coatable material is applied to (e.g., coated on) a substrate to provide the coated substrate. Coatable material is carried on the substrate and is in one embodiment treated to change the viscosity of the coatable material from a first or initial viscosity to a second viscosity. In some embodiments, the first viscosity is lower than the second viscosity so that the coatable material is changed by being thickened or partially cured. In some embodiments, the coatable material may have an initial viscosity that is higher than the second viscosity so that changing the viscosity of the coatable material may require at least some softening of the coatable material. In another embodiment, the viscosity is not changed. Once the viscosity of the coatable material is at a second viscosity, the coatable material is then subjected to contact by a face-side roller, for example, it is brought into contact with the face of a roller, then the coatable material is split between the surface of the face-side roller and the substrate to impart a complex topography on the coatable material remaining on the substrate. The coatable material may then optionally be further hardened, cured, or solidified and the resulting film may be conveyed to another processing station such as a cutting station, or to a wind-up roll, for example. Coatable materials useful in the process of the invention may generally be prepared without the addition of beads, particles, or other matting or texturing agents.

FIG. 1 is a schematic view of one embodiment of a coating capable of carrying out a manufacturing process according to the present invention. Means for providing a coated substrate encompass a coating process within the system 20. In the depicted embodiment, a coated substrate is manufactured as part of the overall manufacturing process within system 20. Uncoated substrate 22 is fed into the system 20 from a source (not shown) such as an extruder, a supply roll or the like. Substrate 22 is conveyed to a first station 24 in an uncoated state, though it may be primed on at least one surface thereof, and travels to the first station 24 where it is picked up by back-up roll 26 so that a major surface of the substrate 22 is in contact with the back-up roll and the idler rollers 32 to advance the substrate 22 through the system 20. The other major surface of the substrate 22 receives coatable material to thereby provide a coated substrate 30. In embodiments of the invention, means for providing a coated substrate may include a source of a pre-coated substrate comprising a polymer coating on a major surface of a backing. The pre-coated substrate may be fed from a feed roll (not shown) directly into the system 20 without requiring an additional coating step via first station 24. In such an embodiment, the pre-coated substrate may be directed into an optional second station, third station or the like, as described herein below.

A large variety of materials may be suitable for use as substrate 22 including flexible materials. Substrate 22 may comprise, for example, films (e.g. polymeric films) including polyamides, phenolic resins, polystyrene, styrene-acrylonitrile copolymers, epoxies, polyolefins, polyesters, and the like. In other embodiments, substrate 22 may comprise or consist of other materials including woven materials, knitted materials, fabrics, nonwovens, metal sheet, metal foils, glass, paper, paper coated with clay, and the like. Mechanical properties can include flexibility, dimensional stability and impact resistance. In some embodiments, an optically clear material (e.g., transparent) may be desired. Examples of suitable optically clear materials include optically clear polyester film, triacetate (TAC) film, polyethylene naphthalate, polycarbonate, cellulose acetate, poly(methyl methacrylate), polyolefins such as biaxially oriented polypropylene (BOPP).

The thickness of the substrate 22 can vary and will typically depend on the intended use of the final article. In some embodiments, substrate thicknesses are less than about 0.5 mm and typically between about 0.02 and about 0.2 mm. Polymeric substrate materials can be formed using conventional filmmaking techniques (e.g., extrusion and optional uniaxial or biaxial orientation of the extruded film). The substrate 22 can be treated to improve adhesion between the substrate and the layer of coatable material. Exemplary of such treatments include chemical treatment, corona treatment (e.g., air or nitrogen corona), plasma, flame, or actinic radiation. Interlayer adhesion can also be improved with the use of an optional tie layer or primer applied to the substrate 22 and/or the coatable material. Substrate 22 may comprise more than one layer, or include other coatings.

The first station 24 provides a means for applying a coatable material to a substrate 22 to form a coated substrate 30 in which the coatable material has a first major surface in contact with the substrate and a second major surface opposite the first major surface. In the embodiment shown in FIG. 1, substrate 22 is provided as a continuous or uncut material. In other embodiments, the substrate may be provided in a discontinuous form or in individual pieces (e.g., pre-cut or pre-made to suit a specific application).

While a first station is provided with die coating apparatus such as an extrusion die in relation to the embodiment of FIG. 1, other coating methods are contemplated and are within the skill of those practicing in the field. The use of die coating is merely exemplary, and other methods of coating may be equally suitable such as slide coating, curtain coating, immersion coating, roll coating, gravure coating, fluid-bearing coating, spray coating and the like. Die coaters of the type generally described in co-assigned U.S. Pat. No. 5,639,305, the disclosure of which is incorporated herein by reference thereto, are suitable for the production of complex topography webs according to the present invention. Additionally, pick and place devices, ink jet and other spray coating technologies may be employed in coating the substrate according to the present invention. Suitable pick and place devices are described in, for example, U.S. Pat. Nos. 6,737,113; 6,878,408; 6,899,922; and 6,969,540 the disclosures of which are incorporated in their entireties herein by reference thereto.

As dispensed onto the substrate 22, the coatable material has a first or initial viscosity and is in contact with the surface of the substrate 22. Means are provided for changing the viscosity of the coatable material from the first or initial viscosity to a second viscosity. In some embodiments, the means for changing the viscosity comprises a means for increasing the viscosity of the coatable material from a first lower viscosity (e.g., as a liquid, paste or gel-like material) to a second higher viscosity (e.g., a partially cured, thickened, somewhat hardened solid). In other embodiments, means for changing the viscosity of the coatable material comprises means for decreasing the viscosity of the coatable material from a first higher viscosity to a second lower viscosity.

In embodiments where the coated substrate has been prepared or obtained in advance of the remainder of the process described herein (e.g., is supplied in the form of a pre-coated substrate), the coatable material is already disposed on the substrate and is likely to already be in a partially cured, thickened or semi-hardened state. In these embodiments, means for changing the viscosity of the coatable material may comprise means for lowering the viscosity of the coatable material to soften it and prepare the first surface of the coated substrate for treatment with face-side rollers, as described herein. In such an embodiment, the pre-coated substrate may be treated to soften the coatable material prior to treatment with face-side rollers to impart a textured finish thereon. Softening of the coated substrate may be accomplished in any suitable manner such as by heating.

In the system 20 of FIG. 1, the coated substrate 30 is conveyed over idler rollers 32, to a second station 34, where the coated substrate is subjected to conditions to change the viscosity by increasing the viscosity of the coatable material from an initial or first viscosity to a second viscosity, the second viscosity being greater than the initial viscosity. In embodiments of the invention, the coatable material, when first applied to the substrate, is typically liquid or gel-like and is flowable or spreadable so as to form a liquid or gel-like layer of material on a major surface of the substrate 22. The coatable material may comprise at least one curable component.

In some embodiments, the coatable material includes at least one solvent and the coatable material is applied directly to the substrate 22. In other embodiments, the coatable material may be solvent-less (e.g., 100% solids) and the coatable material may be applied to a roller and then transferred to the substrate 22.

Second station 34 provides means for changing the viscosity of the coatable material. In the depicted embodiment, the means for changing the viscosity is a means for increasing the viscosity of the coatable material. In embodiments in which the coatable material includes at least one solvent, means for increasing the viscosity of the coatable material may be provided in the form of a heat source such as an oven, a heating element or the like wherein the coatable material is subjected to elevated temperatures sufficient to drive off solvent and/or partially cure at least one component in the coatable material. While in the second station 34, the viscosity of the coatable material is raised to a second or higher viscosity to render the coatable material sufficiently thickened, hardened, dried and/or cured to endure further processing, as is described herein. The exact temperature of the second station 34 will depend, in part, on the composition of the coatable material, the desired viscosity of the coatable material after it exits the second station 34 and the amount of time a coated substrate dwells within the station 34.

In some embodiments, the coatable material may be a polymerizable material in which the polymerization reaction is initiated by the application of electromagnetic radiation. In those embodiments, means for increasing the viscosity of the coatable material may comprise a source of electromagnetic radiation, i.e., ultraviolet (UV) radiation, infrared (IR) radiation, x-rays, gamma-rays, visible light or the like. In some embodiments, the means for increasing the viscosity of the coatable material comprises an electron beam (e-beam) source and the coatable material is curable or otherwise increases viscosity when exposed to an e-beam. In embodiments of the invention wherein the means for changing the viscosity of the coatable material involves temperature control for heating or cooling of the coatable material from a first viscosity to a second viscosity, various mechanisms are contemplated. In some embodiments, the means for changing the viscosity of the coatable material is a temperature-controlled chamber or oven through which the coated substrate passes to adjust the viscosity of the coatable material. In other embodiments, the means for changing the viscosity of the coatable material comprises a temperature-controlled roll that contacts the coated substrate 30 as it advances through the system 20. In some embodiments, means for changing the viscosity of the coatable material comprises a plurality of temperature-controlled rollers. In other embodiments, means for changing the viscosity of the coatable material may comprise a source of temperature-controlled gas. In still other embodiments, means for changing the viscosity of the first coatable material comprises temperature-controlled liquid.

In some embodiments, the coatable material is applied to the substrate as a solventless (e.g. 100% solids) composition that may have its viscosity increased by cooling. Moreover, the coatable material may initially be heated to reduce its initial viscosity and thereby facilitate the initial application of the coatable material onto the substrate 22. Thereafter, the coated substrate 30 may be cooled to increase the viscosity of the coatable material.

In other embodiments, the coatable material may not require either heating or cooling in order to attain an acceptable second viscosity. For some coatable materials in some systems, exposure of the coated substrate in air under ambient conditions may be sufficient to increase the viscosity of the coatable material to permit further processing, as described herein. As mentioned earlier, in some particular embodiments, the modification of the coatable material's viscosity is optional.

Referring again to the system 20 of FIG. 1, coated substrate 30 is conveyed from second station 34 to third station 36 where the second major surface of the coatable material directly contacts one or more face-side rollers 38 having roll features included thereon. In the embodiment shown in FIG. 1, face-side rollers having roll features comprise three rollers 38a, 38b, 38c. It will be understood that fewer face-side rollers (e.g., less than three) or additional face-side rollers (e.g., four or more) may be included within the third station 36. In one embodiment, only one face-side roller having features is used. In addition, face side rollers having features may be combined in station 36 such that some of the face side rollers contain features and some face side rollers are featureless. Coated substrate 30 is maintained in sufficient tension around face-side rollers 38 to generate a resultant texture on the second major surface of the coatable material (by splitting, etc.), as is further described herein. The resultant texture is a complex topography that includes a first area associated with splitting the coatable material between the major surface of the face-side roller and the substrate, and at least one second area associated with splitting between an area of the face-side roller associated with features, such as grooves, and the substrate. Areas within the first area may include interconnected raised ridge features. Areas within the second area include interconnected raised ridge features. In some embodiments, raised ridge features extend between the first areas and second areas.

The coatable material will be at a second viscosity at which the coatable material is not as easy to deform when pressed against face-side rollers 38 as it was when coatable material was first dispensed by the extrusion die 28. In the appropriate environment (e.g., light, electromagnetic radiation, temperature, humidity, etc.), the coatable material will not be excessively hardened to the point that no topography can be imparted to the second major surface of the precursor by face-side rollers 38. Face-side rollers 38 may be selected from any of a variety of rollers made of diverse materials including, without limitation, steel, aluminum, chromed steel, elastomer or elastomer covered rolls such as nitrile rubber surfaced rollers, wood, polymer, ceramic, plastic and the like. While the surface of the face-side rollers may be relatively smooth and featureless, in a preferred embodiment of the invention, the surface of the face-side roller includes roll features which comprise a pattern of grooves inset from the smooth surface of the roller. Other roll features are also possible, including instances where the roll features comprise patterns outset from the smooth surface of the roller.

In some embodiments, the face-side rollers 38 may be heated so that the coatable material is also heated as it contacts the roller 38. In other embodiments, face-side rollers 38 may be chilled or cooled so that the coatable material is also chilled or cooled as it contacts the surface of the rollers 38.

Not wishing to be bound to any particular theory, it is believed that a first chaotic topography is imparted to the second major surface by the interaction of the second major surface of the coatable material and the planar surfaces of the face-side rollers, whereby the coatable material is of sufficient tack that a portion of the precursor material adheres to the surface of the face-side roller. At this point in the process, the coatable material has been subjected to conditions at the second station 34 so that the precursor is cohesive and resistant to flow and will not excessively transfer to the surface of face-side roller 38 or deform when pressed against the face-side roller. However, the outermost layer of the second major surface of the coatable material adheres to the face-side roller, and then splits to create a complex surface topography in the coatable material on the substrate. This same or a similar splitting occurs where areas of the face-side roller having features are brought into contact with the coatable material, but at a different surface (typically a surface recessed from the major surface of the face side roller), resulting in the second area, described above, that is associated with the roll features.

Again, not wishing to be bound by any theory, in some embodiments, a small volume of coatable material may initially adhere to a face-side roller 38. A steady-state condition with respect to splitting is typically achieved as coatable material is continually split between the face-side roller 38 and substrate at nearly the same rate. In other words, an incoming segment of the coated substrate 30 includes coatable material that contacts a face-side roller that has been pre-wetted with the same coatable material from an upstream segment of the coated substrate. As the segment of coatable material contacts the face-side roller, it picks up some of the coatable material already deposited on the roller. As the same segment of coated substrate departs the face-side roll, a portion of the surface layer of the coatable material on the coated substrate splits away so that some of the coatable material remains on the face-side roller while a net amount of coatable material remaining on the substrate is, on average, equal to the amount of the coatable material incoming to the face-side roll.

The process of the invention provides a finish having a complex topography, without painstakingly reproducing the surface features of the face-side roller, and the process of the invention is not a conventional embossing process. Comparisons made during a microscopic examination of the surfaces of the face-side rollers and the resulting textured finish on the second major surface of the coatable material demonstrate that the face-side roller surfaces and the resulting textured finish are not mirror images of one another.

The coated substrate 30 exits the third station 36 with complex topography imparted to the surface thereof by the face-side rollers 38 via the splitting step. Means for further hardening the coatable material are provided in the form of an optional fourth station 40 where the coated substrate 30 is exposed to conditions to harden or cure the coatable material. The fourth station 40 is optional in that the coatable material may not require such a treatment.

In the system 20 shown in FIG. 1, the fourth station 40 includes a source 42 which may be a heat source, e-beam source, or a source of electromagnetic radiation such as ultraviolet (UV) or infrared (IR) radiation, visible light, x-rays, gamma-rays, or the like. In some embodiments, the fourth station is an oven capable of thermally curing the coatable material. In other embodiments, the fourth station is a radiation source capable of initiating a curing reaction within the coatable material. In still other embodiments, the fourth station 40 may comprise a combination of heat and radiation curing, optionally with forced air drying or other features known to those skilled in the art. In still other embodiments, the fourth station may comprise a plurality of individual stations or a plurality of sources similar or analogous to the source 42. In some embodiments, fourth station 40 may be configured to apply the same type of treatment applied by second station 34 (e.g., heating or cooling). An optional deflector or shield 44 deflects heat or radiation emitted from the source 42 and directs it toward the coatable material on the coated substrate 30.

In some embodiments, means for hardening the coatable composition comprises exposure to ambient conditions while, for example, a free radical polymerization process within the coatable material runs to completion.

Following hardening, the coated substrate 30 may be conveyed to another station (not shown) such as a cutting station to cut the continuous coated substrate into smaller discrete sections. Alternatively, the coated substrate may be directed to a wind-up station where the continuous coated substrate is wound up on a take-up roll, for example. Other process stations (e.g., a packaging station) may be included in the system 20, depending on the use of the final article.

The present invention provides webs and the like having a surface with a complex topography comprising an interconnected network of raised ridge features that are made from coatable materials via contact with one or more face-side rollers. The invention enables the manufacture of webs that may be suitable for liner-type applications using initially flowable, low viscosity, coatable materials. The interconnected network of raised ridge features may be used to endow an adhesive layer on another further film with a negative structure corresponding to the raised ridge features, such structure controlling the adhesion interface, for example, which may assist in facilitating air egress during installation of the other film. Moreover, the use of such flowable, low viscosity, coatable materials enables the manufacture of articles having thin films coated onto a suitable substrate. In some embodiments, the resulting thin film has an average thickness of at least about 1 micron. In some embodiments, the resulting thin film is provided with a thickness between about 1 micron and about 10 microns on top of the substrate. In still other embodiments, the coated average thickness of the resulting film is greater than about 10 microns.

In the foregoing embodiment, the plurality of face-side rollers 38 can be provided in other arrangements and configurations, all contemplated within the scope of the present invention. The various arrangements of face-side rollers, embodiments of which are discussed below, can alter the properties of the final textured finish. Additionally, the final textured finish can be influenced by controlling the temperature of the coated substrate within third station 36. Thermal control of the coated substrate at this stage of the manufacturing process can further influence the viscosity of the coatable material and the behavior of the coatable material on the face-side rollers 38 as previously discussed, where a portion of the surface layer of the coatable material on the coated substrate splits with some of the coatable material remaining on the face-side roller while a net amount of coatable material remains on the substrate. Means for hardening the coatable material can include the heating or cooling of the third station 36 by, for example, heating the face-side rollers so that the coated substrate 30 is also heated, thus changing the properties (e.g., viscosity) of the coatable material and the manner in which the surface of the coatable material may split between the face-side rollers and the substrate. By changing the manner in which the coated substrate interacts with the face-side rollers, the quality and/or properties (e.g., fidelity of the raised ridge features) of the textured finish can also be changed, which may make the liner more suitable for certain applications.

In some embodiments, both the face-side rollers and the coated substrate are exposed to heating or cooling conditions in a manner that influences the viscosity of the coatable material as it is exposed to the face-side rollers. Thermal control of third station 36 can be accomplished by enclosing third station 36 to permit heating/cooling of the atmosphere therewithin.

In other embodiments, thermal control of face-side rollers 38 can be achieved by directly heating or cooling the face-side rollers and/or backing rollers. Such heating or cooling can be accomplished in a known manner (e.g., by use of heating coils or by circulating fluids through the rollers) in order to change the viscosity of the first coatable material. Other arrangements for the thermal control of the third station 36 and/or the face-side rollers 38 are within the skill of those practicing in the field.

In some embodiments, the entire system 20 may be enclosed to prevent coatable material (e.g., resin) on the face-side rollers 38 from hardening (e.g., polymerizing) under ambient light. Such an enclosure may be provided in the form of a shroud constructed to block the transmission of light or other electromagnetic radiation while being transparent enough to facilitate viewing of the process. In some embodiments, the enclosure or shroud may be configured so that it can be purged (e.g., with filtered gas) to further minimize contamination on the face-side rollers. Moreover, in systems employing a polymerizable material as the coatable material, the purge gas is chosen to prevent premature curing. The enclosure may also be equipped to collect volatilized or aerosol dispersed coating material.

Operation of the foregoing process in a “clean” environment may be desirable to prevent defect formations in the coating caused by, for example, one or more stray particles in the coatable material. Unwanted particles can disrupt the desired contact between the coated film and the face-side roller(s), thus creating a “point” defect in the vicinity of the particle.

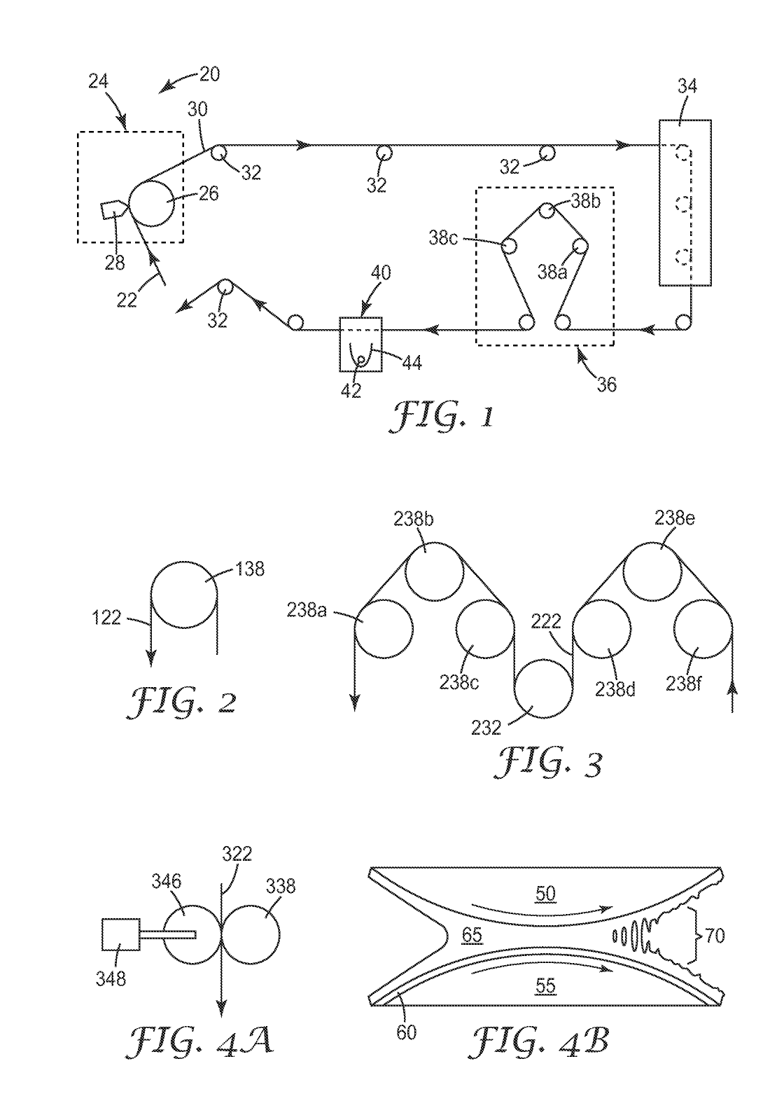

Referring now to FIG. 2, another embodiment is shown in schematic for the arrangement of face side rollers according to the present invention. In FIG. 2, a single face-side roller 138 provides the network of raised ridge features to the coatable material disposed on substrate 122. The face-side roller 138 may be inserted into the system 20 shown in FIG. 1 in place of the face-side rollers 38a, 38b and 38c within third station 36.

In another embodiment, a greater number of face-side rollers may be used, as shown in FIG. 3, for example. In the depicted embodiment, a plurality of six face-side rollers 238 a-f are used to impart a complex topography on the coatable material disposed on substrate 222. In the depicted arrangement, the face-side rollers 238 are grouped in two sets of three rollers each, rollers 238a-c being a first group of face side rollers, and rollers 238d-f being a second group of face-side rollers. Idler roller 232 guides the coated substrate 222 between the two groups of face-side rollers. Again referring to the system 20 in FIG. 1, the plurality of face-side rollers 238 of FIG. 3 may be substituted into the system 20 in place of the face-side rollers 38a-c in third station 36. Any, all, or none of these face side rollers may include roll features inset to the facial plane of the roller (or outset, as the case may be), depending on desired characteristics of the resultant web.

Other combinations of face-side rollers are also contemplated. In another embodiment, a face-side roller may be brought into contact with the second surface of the coatable material using a nip arrangement as shown in FIG. 4A, for example. In this embodiment, face-side roller 338 is paired with a backing roller 346. The face-side roller contacts the second surface of the coatable material on coated substrate 322 which is carried on backing roller 346. The coated substrate 322 is conveyed between the face-side roller 338 and the backing roller 346 with the backing roller capable of being moved relative to the face-side roller 346 to thereby move the second surface of the coatable material on coated substrate 322 into contact with face side roller 338 as well as to adjust the force at which the second surface is held against the face-side roller 338. In the embodiment of FIG. 4A, actuator 348 is provided to control the placement of the coated substrate 322 with respect to the face-side roller 338. The face-side roller may also be positionally changed relative to the coated substrate. Actuator 348 can be of any appropriate design including without limitation pneumatic, hydraulic, piezoelectric, electromechanical and the like. In this manner, pressure is exerted on the face-side roller 338 through the actuator 348 in a controlled manner.

It will be appreciated that the nip arrangement of face-side roller 338 paired with backing roller 346 can be combined with other configurations of face side rollers, including those embodiments already discussed with respect to FIGS. 1-3. The nip arrangement can be configured within the system 20 of FIG. 1, for example, to receive the coated substrate fed from face-side roller 38C prior to exposing the coated material to conditions sufficient to achieve a final hardening or curing, as are provided in fourth station 40. Similarly, face-side roller 338 and backing roller 346 can be combined with face-side rollers of FIG. 2 so that the coated substrate 122 leaving face-side roller 138, for example, is routed through the nip arrangement of FIG. 4A. Likewise, face-side roller 338 and backing roller 346 can be combined with face-side rollers of FIG. 3 so that the coated substrate 222 leaving face-side roller 238a, for example, is routed through the nip arrangement of FIG. 4A. Alternatively, single or multiple nip arrangements similar to the one depicted in FIG. 4A may precede or reside between any number of face-side rollers and arrangements.

FIG. 4B shows, in a setup similar to that which is described with respect to FIG. 4A, a drawing illustrating how coatable material 65 splits between face-side roller 50 and the backing roller 55. Both rollers rotate in the direction indicated by the arrows, ie, consistent with the direction of the substrate, and generally having the same velocity at the surface as the web. Backing roller 55 carries coated substrate 222 through a nip arrangement, and coatable material 65 is split between the face-side roller and the substrate 60 (at 70). Material split to the face-side roller at 70 may go around the face-side roller to re-enter the nip arrangement after a revolution. Material split to the substrate is endowed with a substantially interconnected network of raised ridge features, some associated with areas of the face-side roller associated with the major surface thereof, and other features associated with areas associated with grooves inset in the major surface of the face-side roller. Similar splitting would happen in other embodiments, including those associated with FIGS. 1-3, as described herein.

In embodiments of the invention, multiple (e.g., two or more) face-side rollers are employed in the creation of the desired complex topography. In some embodiments, the multiple face-side rollers are of varying diameters. In some of these embodiments, each of the face-side rollers will be of a different diameter. Other arrangements of face-side rollers will be apparent to those of ordinary skill in the art, and all such arrangements are contemplated as being within the scope of the invention. The wrap angle of the substrate and coating around each face-side roll may also be varied by those skilled in the art to impart different levels of textured finish and optical properties.

In another aspect of the invention, a method of providing a web with a complex topography is provided. The method includes providing a coated substrate comprising a coatable material on a substrate. In some embodiments, the providing step comprises providing a pre-coated substrate that can be fed directly into the system described herein. In other embodiments, the providing step comprises the step of making the coated substrate by applying a coatable material onto a substrate, the coatable material having an initial viscosity, the coatable material and the substrate forming a coated substrate in which the coatable material has a first major surface in contact with the first major surface of the substrate and a second major surface opposite the first major surface. Once the coated substrate is provided, the method of the invention comprises changing the viscosity of the coatable material from the initial viscosity to a second viscosity; contacting the second major surface of the coatable material with at least one face-side roller, splitting the coatable material between the face-side roller and the coated substrate to impart a complex topography in the coated substrate comprising an interconnected network of raised ridge features; and, optionally, hardening the coatable material to provide the film having an ensuant complex textured surface. In some embodiments, changing the viscosity from a first to a second viscosity is not necessary.

Coatable materials suitable for use in the present invention may comprise any of a variety of film forming materials. In some embodiments, the coatable material is a polymeric material comprised of one or more polymers and/or oligomers in solvent. In some embodiments, the coatable material is a mixture of one or more monomers, oligomers and/or polymers in one or more solvents. In other embodiments, the coatable material includes the foregoing oligomer(s), monomer(s) and/or polymer(s) in one or more solvents along with a volume of particles or nanoparticles. Some examples of photocurable coatable materials include radical photocurable acrylate and methacrylate functional materials, photocurable materials such as TEGO™ RC902 and RC922 available from Evonik (Essen, Germany), cationic photocurable epoxy silicones, and cationic photocurable silicones, etc.

In some embodiments, the polymerizable composition or an underlying layer preferably contain (e.g. surface modified) inorganic particles that add mechanical strength and durability to the resultant coating. Such particles are further described in US Publication No. 2009/0004478, “Flexible Hardcoat Compositions, Articles, and Methods”, the disclosure of which is hereby incorporated by reference.

Nanoparticles can be surface modified which refers to the fact that the nanoparticles have a modified surface so that the nanoparticles provide a stable dispersion. “Stable dispersion” refers to a dispersion in which the colloidal nanoparticles do not agglomerate after standing for a period of time, such as about 24 hours, under ambient conditions, e.g., room temperature (about 20-22° C.), and atmospheric pressure, without extreme electromagnetic forces.

Surface-modified colloidal nanoparticles can optionally be present in a polymer coating used as a coatable composition herein with nanoparticles present in an amount effective to enhance the durability of the finished or optical element. The surface-modified colloidal nanoparticles described herein can have a variety of desirable attributes, including, for example, nanoparticle compatibility with a coatable composition such that the nanoparticles form stable dispersions within the coatable composition, reactivity of the nanoparticle with the coatable composition making the composite more durable, and a low impact or uncured composition viscosity. A combination of surface modifications can be used to manipulate the uncured and cured properties of the composition. Surface-modified nanoparticles can improve properties of the coatable composition such as, for example, improved resin mechanical strength, minimized viscosity changes while increasing solids volume loading in the coatable composition and the maintenance of optical properties (such as clarity) while increasing solid volume loading in the coatable composition.

In some embodiments, the nanoparticles are surface-modified nanoparticles. Suitable surface-modified colloidal nanoparticles can comprise oxide particles. Nanoparticles may comprise a range of particle sizes over a known particle size distribution for a given material. In some embodiments, the average particle size may be within a range from about 1 nm to about 100 nm. Particle sizes and particle size distributions may be determined in a known manner including, for example, by transmission electron microscopy (TEM). Suitable nanoparticles can comprise any of a variety of materials such as metal oxides selected from alumina, tin oxide, antimony oxide, silica, zirconia, titania and combinations of two or more of the foregoing. Surface-modified colloidal nanoparticles can be substantially fully condensed.

In some embodiments, silica nanoparticles can have a particle size ranging from about 5 to about 75 nm. In some embodiments, silica nanoparticles can have a particle size ranging from about 10 to about 30 nm. Silica nanoparticles can be present in the coatable composition in an amount from about 10 to about 100 phr. In some embodiments, silica nanoparticles can be present in the coatable composition in an amount from about 25 to about 80 phr, and in other embodiments, silica nanoparticles can be present in the coatable composition in an amount from about 30 to about 70 phr. Silica nanoparticles suitable for use in the coatable compositions of the present invention are commercially available from Nalco Chemical Co. (Naperville, Ill.) under the product designation NALCO COLLOIDAL SILICAS. Suitable silica products include NALCO products 1040, 1042, 1050, 1060, 2326, 2327 and 2329. Suitable fumed silica products include for example, products sold under the tradename AEROSIL series OX-50, -130, -150, and -200 available from DeGussa AG, (Hanau, Germany), and CAB-O-SPERSE 2095, CAB-O-SPERSE A105, CAB-O-SIL MS available from Cabot Corp. (Tuscola, Ill.) Surface-treating the nanosized particles can provide a stable dispersion in the coatable composition (e.g., a polymeric resin). Preferably, the surface-treatment stabilizes the nanoparticles so that the particles will be well dispersed in the coatable composition and results in a substantially homogeneous composition. Furthermore, the nanoparticles can be modified over at least a portion of its surface with a surface treatment agent so that the stabilized particle can copolymerize or react with the coatable composition during curing.

Metal oxide nanoparticles can be treated with a surface treatment agent. In general, a surface treatment agent has a first end that will attach to the particle surface (covalently, ionically or through strong physiosorption) and a second end that imparts compatibility of the particle with the coatable composition and/or reacts with coatable composition during curing. Examples of surface treatment agents include alcohols, amines, carboxylic acids, sulfonic acids, phosphonic acids, silanes and titanates. The type of treatment agent can depend on the nature of the metal oxide surface. For example, silanes are typically preferred for silica and other siliceous fillers. Surface modification can be accomplished either subsequent to mixing with the coatable composition or after mixing. It may be preferred in the case of silanes to react the silanes with the particle or nanoparticle surface before incorporation into the coatable composition. The amount of surface modifier can depend on factors such as particle size, particle type, modifier molecular weight, and modifier type. In general, a monolayer of modifier is attached to the surface of the particle. The attachment procedure or reaction conditions required also depend on the surface modifier used. For silanes, surface treatment may take place at elevated temperatures under acidic or basic conditions during a period of 1 hour up to about 24 hours.

Surface treatment agents suitable for particles to be included in the coatable composition include compounds such as, for example, isooctyl trimethoxy-silane, N-(3-triethoxysilylpropyl) methoxyethoxyethoxyethyl carbamate (PEG3TES), Silquest A1230, N-(3-triethoxysilylpropyl) methoxyethoxyethoxyethyl carbamate (PEG2TES), 3-(methacryloyloxy)propyltrimethoxysilane, 3-acryloxypropyltrimethoxysilane, 3-(methacryloyloxy)propyltriethoxysilane, 3-(methacryloyloxy) propylmethyldimethoxysilane, 3-(acryloyloxypropyl)methyldimethoxysilane, 3-(methacryloyloxy)propyldimethylethoxysilane, 3-(methacryloyloxy) propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane-, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate, 2-(2-methoxyethoxy)acetic acid, methoxyphenyl acetic acid, and mixtures of two or more of the foregoing.

Surface modification of the particles in a colloidal dispersion can be accomplished in a number of ways. The process involves the mixture of an inorganic dispersion with surface modifying agents and, optionally, a co-solvent such as, for example, 1-methoxy-2-propanol, ethanol, 2-propanol, ethylene glycol, N,N-dimethylacetamide and 1-methyl-2-pyrrolidinone. Co-solvent can be added to enhance the solubility of the surface modifying agents as well as the surface modified particles. The mixture comprising the inorganic sol and surface modifying agents is subsequently reacted at room or an elevated temperature, with or without mixing. In one method, the mixture can be reacted at about 85° C. for about 24 hours, resulting in the surface-modified sol. In one method, where metal oxides are surface-modified, the surface treatment of the metal oxide can involve the adsorption of acidic molecules to the particle surface. The surface modification of the heavy metal oxide preferably takes place at room temperature.

In applications where the film substrate, after the splitting step, is to be used as a liner, additives may be included in the composition of the coatable material to enhance the “release” property of the cured coatable material. Surprisingly, surface active materials, such as release-facilitating additives, are found at the interface created by the splitting process. Release additives may be chosen from silicones having polymerizable functional groups such as acrylates including those sold under the trade name TEGO™RAD series and TEGO™RC902 and RC922, available from Evonik (Essen, Germany) or methacrylates, thiol functional silicones, fluorine containing materials (monomers, oligomers, polymers) which may or may not have functional groups such as acrylates or methacrylates. More description of such materials may be found in the patent application referenced above, “Flexible Hardcoat Compositions, Articles, and Methods”, paragraphs 25 through 34.

The end product of the foregoing manufacturing process is a web having a complex topography including an interconnected network of raised ridge features. The web may be used in any of a variety of applications. In some embodiments, the web resulting from the foregoing process is used in liner applications to endow an adhesive layer with a structure corresponding to the mold negative of the complex topography. In other embodiments, such resultant structured adhesive may facilitate air egress when applying a graphic film.

In some embodiments, the foregoing process is used to manufacture an article as previously described, wherein the coatable material comprises more than one phase. In aspects of this embodiment, the coatable material is applied to the substrate to provide a coated substrate having a phase-separated coatable material thereon. The coatable material may be formulated and applied to the substrate so that it forms two or more phases after application to the substrate. In another aspect, the coatable material may be formulated and allowed to phase separate prior to its application to the substrate. In either aspect, the resulting coatable material may then be hardened, as previously described, resulting in a phase-separated film layer on a major surface of the substrate. The phase-separated film layer is then further processed to provide a complex topography surface, according to the present invention.

In a further embodiment, the process of the invention is included as part of a larger or more complex process capable of providing articles (e.g., films) having the aforementioned properties (for example, the interconnected network of raised ridge features) as well as other properties. For example, articles having harder polymeric coatings may be desired. Depending on the materials used, harder coatings may require a minimum thickness in order to obtain desired mechanical properties such as abrasion resistance while obtaining the desired optical properties of a textured finish may require a thinner coating or layer of coatable material. In a tandem process, according to the present invention, a first coating of coatable material X could be applied to the substrate to obtain the needed thickness, and a subsequent application of a coatable material Y may be applied to the surface of coatable material X. The coatable material X may be solidified (e.g., cured) without subjecting it to treatment by the face-side rollers. Coatable material Y can then be applied to the surface of coatable material X and treated with face-side rollers as described herein to obtain the desired complex topography finish on the surface of the finished article.

In other embodiments of the invention, a process is provided to manufacture articles (e.g., films) wherein a coatable composition is applied to both sides of the substrate, either sequentially or simultaneously. In a sequential dual side coating process, an article made as described above with reference to FIG. 1, the coated substrate 30 may be re-directed from the fourth station 40 into first station 24 where a second layer of coatable material would be applied to the opposite or previously uncoated side of the substrate 22. Thereafter, the second layer of coatable material would be processed in the same manner as previously described with respect to the system 20. In some embodiments, the second layer of coatable material would also be subjected to treatment by face-side rollers to impart a complex topography finish thereon so that the resulting article comprises a substrate having a layer of hardened coatable material on each major surface thereof and wherein each layer of the hardened coatable material includes a complex topography finish including an interconnected network of raised ridge features. In other embodiments, the second layer of coatable material is applied to the previously uncoated major surface of the substrate and hardened without subjecting the second layer to a surface finishing treatment by face-side rollers. Articles provided in the foregoing process comprise substrate having a layer of hardened coatable material on each major surface thereof wherein only one layer of the hardened coatable material includes a complex topography finish. In the foregoing embodiment, it is contemplated that each layer of hardened coatable material may be the same composition or they may be different.

In a simultaneous dual side coating process, coatable materials are applied simultaneously to both sides of a substrate to provide a dual coated substrate with a first coatable material on a first major surface of the substrate and a second coatable material on the second major surface of the substrate. Suitable coating methods include vertical coating, wherein the substrate is fed vertically through a coating station for the simultaneous application of the first coatable material and second coatable material to both sides of the substrate. The first and second coatable materials applied in such manner can be the same materials or they can be different. Thereafter, the second layer of coatable material would be processed in a similar manner as previously described with respect to the system 20 by hardening the first coatable material and the second coatable material simultaneously with a heat source, e-beam source, a source of the electromagnetic radiation, a combination of the foregoing or the like. Thereafter, the first coatable material and/or the second coatable material may be subjected to treatment by face-side rollers to impart a complex topography finish thereon so that the resulting article comprises a substrate having a layer of hardened coatable material on each major surface thereof and wherein one or both of the layers of the hardened coatable material includes a textured finish. Articles provided in the foregoing simultaneous process comprise a substrate having a layer of hardened coatable material on each major surface thereof. It is contemplated that each layer of hardened coatable material may be the same composition or they may be different. The webs thus described may be used as releasable webs (liners) for making further films and the like having complex topography. When the web is used as a liner, after it has been manufactured according to the above described process, a further film is formed on the releasable liner (or otherwise brought into contact with it—for example, certain further films may be pressed into the releasable liner, sometimes with heat and pressure). The surface of the further film is formed on the releasable web or brought into contact with the releasable web such that it ‘molds’ into and around the textured surface of the releasable liner. Removal of the release liner from the further film reveals that the surface of the further film brought into contact with the textured liner substrate has assumed, in negative, the topological characteristics of the release liner. Films may be formed on the releasable liner by contacting steps such as casting techniques, coating techniques, and compressing techniques. An example of a coating technique would be to coat onto the liner film a solution or mixture of a film forming material that would then be processed with heat to remove solvent or water and/or to cure the material to give appropriate film properties. Other energy sources may be used for the curing step, depending on the material. Other well known energy sources that promote curing of the components, for example by polymerization or crosslinking, include e-beam or electromagnetic radiation such as ultraviolet (UV), infrared (IR) radiation, visible light, x-rays, gamma-rays, or the like.

Further films made by the coating technique may be solvent based, water based, or 100% solids and may include a variety of film-forming materials. Nonlimiting examples of films or their film formers include polyolefins, acrylics, plasticized poly(vinylchloride) (including organosols of plasticized PVC, 100% solids plastisols of plasticized PVC, and premade PVC films; see for e.g. Plastisols and Organosols, Harold A. Sarvetnick, Ed.; Robert E. Krieger Publishing Company; Malabar, Fla., 1983 and those described in U.S. Pat. No. 5,874,158), polyurethanes, cellulosic esters, polyvinyl acetals, styrene containing polymers, and modified or blended versions, etc.

The liner webs made according to the description provided herein may also be used as releasable liners for making a structured adhesive layer having complex topography. In such an embodiment, an adhesive is contacted to a releasable liner by contacting steps that may include casting techniques, coating techniques, and compressing techniques. These techniques bring the adhesive into intimate contact with the complex topography of the liner films. Various energy sources may then be used to dry or cure the adhesives where appropriate. Suitable adhesives can be selected from a variety of conventional adhesive formulations. Non-limiting examples of adhesives include pressure sensitive adhesives, heat activated adhesives, radiation curable adhesives, and the like. Examples of formulation types include solvent-based solutions, water-based, latex, microspheres, hot melt coatable, and suitable combinations thereof.

Potentially useful pressure sensitive adhesives suitable for bringing into contact with liner-type webs described herein typically have pressure-sensitive adhesive properties as described in The Handbook of Pressure Sensitive Adhesives, page 172, paragraph 1 (1989). The pressure-sensitive adhesive could be a single pressure-sensitive adhesive or the pressure sensitive adhesive could be a mixture of several pressure-sensitive adhesives. Classes of pressure sensitive adhesives useful in the present invention include, for example, rubber resin materials such as tackified natural rubbers or those based on synthetic rubbers, styrene block copolymers, polyvinyl ethers, acrylic resins such as poly(meth)acrylates (including both acrylates and methacrylates), polyurethanes, poly-a-olefins, silicone resins, and the like. Combinations of these adhesives can be used. Additionally, further useful adhesives include those that may be activated at elevated temperature for application at use temperature. These generally meet the Dahlquist criterion at use temperature.

The pressure sensitive adhesive may be inherently tacky. If desirable, tackifiers may be added to a pressure sensitive adhesive base material to form the pressure sensitive adhesive. Useful tackifiers include, for example, rosin ester resins, aromatic hydrocarbon resins, aliphatic hydrocarbon resins, mixed aromatic/aliphatic hydrocarbon resins, and terpene resins. Other materials can be added for special purposes, including, for example, oils, plasticizers, antioxidants, ultraviolet (“UV”) stabilizers, hydrogenated butyl rubber, pigments, fillers, curing agents, and crosslinkers. Some examples of fillers or pigments include zinc oxide, titanium dioxide, silica, carbon black, metal powders and calcium carbonate.

Acrylic pressure-sensitive adhesives having a wide range of compositions are useful. Typically, the components of the compositions are selected such that the compositions have a glass transition temperature of less than about −20 C. The compositions typically comprise about 70 to 100 weight percent of alkyl ester components, for example, alkyl acrylate components having alkyl groups from 1 to 14 carbons, and about 30 to 10, or 2, or in some cases 0 weight percent of polar interacting components, for example, ethylenically-unsaturated carboxylic acids or ethylenically unsaturated amides. In some embodiments, preferably the compositions may comprise about 70 to 98 weight percent of alkyl ester components and about 30 to 2 weight percent of polar interacting components, and most preferably about 85 to 98 weight percent alkyl ester components and about 15 to 2 weight percent of polar interacting components. The alkyl ester components include, for example, isooctyl acrylate, 2-ethyl-hexyl acrylate, methyl acrylate, ethyl acrylate, n-butyl acrylate, 2-methylbutyl acrylate, isobornylacrylate, and the like. The compositions may include other types of ester components such as, for example, vinyl acetate, methyl methacrylate, and the like. The polar interacting components include, for example, acrylic acid, methacrylic acid, N-vinyl pyrrolidone, N-vinyl caprolactam, methacrylamide, acrylamide, N-alkyl acrylamides, 2-hydroxyethyl acrylate, and the like. The compositions may include other components such as, for example, styrene macromer, and the like.

The acrylic pressure sensitive adhesives may be self-tacky or tackified. Non-limiting examples of potentially useful tackifiers for acrylics are rosin esters such those available under the following trade names: FORALTM 85, available from Hercules, Inc.; aromatic resins such as PICCOTEXTM LC-55WK; aliphatic resins such as PICCOTACTM 95, available from Hercules, Inc.; terpene resins such as a-pinene and p-pinene, available as PICCOLYTETM A-115, ZONAREZTM B-100 from Arizona Chemical Co., and terpene-phenol resins such as SYLVARES TP 2019 from Arizona Chemical Co.

The performance (tack, peel adhesion, shear adhesion, adhesion to specific substrates) of pressure sensitive adhesives can be tailored to a given application by using crosslinking agents, plasticizers, or other modifiers.

Crosslinking agent(s) can be used if so desired to build the molecular weight and the strength of the adhesive during a curing process. The crosslinking agent(s) may produce chemical crosslinks (e.g., covalent bonds or ionic bonds). Alternatively, it may produce thermally reversible physical crosslinks that result, for example, from the formation of reinforcing domains due to phase separation of hard segments and/or from acid/base interactions within the same polymer or between polymers or between a polymer and an additive. For some formulations, the crosslinking agent(s) may be incorporated into the adhesive polymers or and/or may be added to the adhesive formulation. Crosslinking may use thermally induced reactions. The crosslinking agent may be a chemical crosslinker which generates free radicals to carry out the crosslinking reaction. The crosslinking agent may be a photosensitive crosslinker which is activated by high intensity (UV) light. Other energy sources may be used for generating crosslinks, depending on the material. Examples of energy sources that may promote curing of adhesive include thermal sources, e-beam or electromagnetic radiation such as, for example, ultraviolet (UV), x-rays, gamma-rays, and the like. Examples of further suitable pressure sensitive adhesives include those described in U.S. Pat. No. 4,994,322 (Delgado et. al.); (U.S. Pat. No. 4,968,562 (Delgado); EPO Publication 0 570 515; EPO Publication 0 617 708; U.S. Pat. Nos. 5,296,277 and 5,362,516 (both Wilson et. al.) and U.S. Pat. No. 5,141,790 (Calhoun et. al.) and U.S. Pat. No. 5,795,363 (Keller et. al.), all incorporated by reference, and any other type of suitable pressure sensitive adhesive. The adhesive can cover all or a part of the surface of the releasable film liner, for example by pattern coating, depending on the desired result. Film backings, including thick articles, or graphic films, or films that are to be printed upon, can be contacted to the major surface of adhesive opposite the surface that contacts the textured surface of the releasable liner. Prior to applying the adhesive backed article to a substrate, removal of the textured releasable film liner exposes the structured adhesive surface that is the negative mold of the release liner. The structured adhesive thus includes channels that may facilitate air egress during installation of the film backing. For example, an installer might use a squeegee or hand to push to the edge air pockets or bubbles that have formed under the film. Film backings may be made from a variety of materials and may also have primer, surface treatments, or other layers. Nonlimiting examples of such film backings include foils, metallic plates, ceramic plates, polymeric sheets, paper based sheets, vibration damping materials, reflective sheeting, retroreflective sheeting, top-coated materials, industrial tape backings, medical tape backings, graphic film materials, and combinations thereof.

The liner films made according to the description provided herein may also be used to endow further articles with a topography, in negative, of the topography of the liner films. For example, a further article may be manufactured by contacting a formable material with the liner film. Such further articles may comprise graphic film articles, decorative films, etc. The interconnecting networks of ridge features in the liner film would correspond, in some embodiments, to channel features in the further articles. Such channel features may promote drainage of water or aerodynamic qualities. The further article may be pigmented. Such contacting may comprise embossing, in some embodiments in the presence of heat and pressure; or casting or coating of formable materials onto the liner film. After such casting or coating or embossing, the formable material may be cured (if applicable) using suitable methods (UV, e-beam, etc.). Potentially applicable coating process may include roll coating, knife coating, slot die coating, gravure coating, slide coating, curtain coating, etc. Additionally, the process described in US Publication No.: 2013/0140738 “Method of Preparing Benzoxazine-Thiol Polymers Films” (Gorodisher and Johnson), hereby incorporated by reference, describes a process whereby a formable material may be cast upon a liner created according to the above description. Articles manufactured as a result of such a process may include graphic films, paint protection films, anti-graffiti films, car wrap films, ovarlaminate films, architectural films, and signage films, to name a few. The formable material may comprise a thermoformable film, a thermoset film, an embossable film, etc. It may comprise organisols or plastisols, or any other suitable material. In some embodiments associated with such further articles, the face-side roller itself may be featureless.

### EXAMPLES

Embodiments of the invention are further described in the following non-limiting Examples.

### Example 1A

A system similar to that shown in FIG. 1 was used, except the third station 36 comprised a nip-type setup similar to that shown in FIG. 4A. The line speed was 50 feet per minute (15.2 meters/minute), and a coating die of the type discussed in co-assigned U.S. Pat. No. 5,639,305 was used to deposit a 8 inch (20.3 cm) wide layer of a coatable material at target dry thickness of 4 micrometers after drying but before entering the nip of the face-side roller, onto a 9 inch (22.9 cm) wide by 0.005 inch (0.13 mm) thick, polyester film. A conventional pump was used to supply the coatable material to the die which fed the coatable material onto the primed polyester film using a gap setting of 0.0035 inches (0.089 mm) and a flow rate of 46.6 grams/minute. The coated substrate was conveyed into a three zone drying oven having zone temperatures of 120° F. (49° C.), 120° F. (49° C.), and 75° F. (24° C.) respectively to remove volatile solvent and raise the viscosity of the coatable material to provide a coated substrate with a higher viscosity coatable material thereon.

### Coating Line

Substrate was unwound and delivered to the extrusion die coating station at 50 feet per minute. Coating material, described below, was pumped from a hopper, through a filter, and delivered to the extrusion die by a metering pump at various flow rates to achieve target dry thickness at 203.2 mm wide. The coated substrate was delivered to a drying oven to thicken the coated material by removing solvent. After thickening, the coated substrate was delivered to the face-side roller splitting step.

### Coating Material

The coating material for this example was compounded starting with a mixture of 1014.9 g of a resin consisting of 60 wt % acrylic monomers and 40 wt % 5 nm silica treated with 1.75 mmole/gram silica of a 75:25 molar ratio of A174:PEG2TES.

“PEG2TES” refers to N-(3-triethoxysilylpropyl) methoxyethoxyethyl carbamate. It was prepared as follows prior to treatment of the silica: A 250 ml round-bottomed flask equipped with a magnetic stir bar was charged with diethylene glycol methyl ether (35 parts by weight) and methyl ethyl ketone (77 parts by weight). A majority of the solvent was removed via rotary evaporation to remove water. 3-(Triethoxysilyl)propylisocyanate (68.60 parts by weight) was charged to the flask. Dibutyltin dilaurate (0.003 parts by weight) was added and the mixture stirred. The reaction proceeded with a mild exotherm. The reaction was run for approximately 16 hr at which time infrared spectroscopy showed no isocyanate. The remainder of the solvent and alcohol were removed via rotary evaporation (90° C.) to yield PEG2TES as a somewhat viscous fluid (104.46 parts by weight).

The surface treated silica for this mixture was made as follows. The colloidal silica (colloidal silica having a particle size of 5 nanometers, at 16.4% in aqueous medium, available as NALCO 2326 from Nalco Company, Napierville, Ill.) was surface treated as generally described in Example 3 of U.S. Pat. No. 6,467,897. Briefly, the colloidal aqueous silica was combined in a glass jar and mixed with methoxy propanol solvent and 1.75 millimoles/gram SiO₂ of a 75:25 (molar ratio) mixture of gamma-methacryloxypropyltrimethoxysilane (SILQUEST A-174, available from Momentive Performance Materials Incoporated, Columbus, Ohio) and PEG2TES silane. 125 ppm each of BHT (butylated hydroxytoluene) and penothiazine based on solids was also added to suppress reaction of the methacrylated silane during this silica treatment step. The mixture was then heated at 80° C. for between 16 and 22 hours producing a clear blue nonviscous colloidal dispersion of surface treated silica.

The acrylate monomer portion of this resin consisted of a 42.075/42.075/14.85/1 weight ratio of SR247/SR9003B/SR259/Darocure 4265, all monomers available from Sartomer USA, LLC, 502 Thomas Jones Way, Exton, Pa. 19341 and Darocure 4265 photoinitiator available from BASF Corporation, North America Regional Headquarters, 100 Park Avenue, Florham Park, N.J. 07932. This acrylate mixture had previously been combined with the treated silica sol in a rotary evaporator and stripped to remove the water and organic solvent. To this stripped mixture was added 1980 g isopropanol solvent and 5.1 g Darocure 1173 (second photoinitiator). 1885 g of this mixture was then poured into another container and 33.73 g of a radically cross-linkable, silicone acrylate was added (available as TEGOTMRAD 2700 from Evonik, Essen, Germany) and mixed in preparation for coating.

After drying, the coated substrate was delivered to the face-side roller splitting station as shown in FIG. 4A. The system was operated for 30 seconds after initial contact of the face-side roller with the coatable material so that a steady state was reached. After the splitting step, the substrate with a textured coating was promptly transported to the UV chamber where the coatable material was cured and then wound into a roll.

### Face-Side Roller Setup

The face-side splitting step was accomplished by delivering the substrate with coatable material into a nip between the face-side metal roller and a rubber covered backing roll. The surface of the face-side roller had a smooth chrome finish. The face-side roller had an outer diameter of 3 inches (7.62 cm) and a width of 10 inches (25.4 cm). Grooves were inset into the major surface of the face-side roller using typical machining techniques, in a down-web type pattern similar to that shown with respect to FIG. 5a. A cross-sectional profile of the grooves is shown in FIG. 12.

The face-side roller was brought into contact with the surface of the coatable material by a 1 inch (2.54 cm) diameter, pneumatically actuated cylinder. The cylinder pressure was 90 psig (0.62 megapascal gauge pressure). The backing roll had an outer diameter of 3 inches (7.62 cm) and a width of 10 inches (25.4 cm). The rubber cover of the backing roll was 0.375 inches thick (9.52 mm), had a Shore A hardness of 60, a surface roughness (Ra) of 64, was made from HYPALON (chlorosulfonated polyethylene synthetic rubber), and obtained from Valley Roller Company, Appleton, Wis.

The face-side roller had an array of grooves in the surface, a subset of which are shown in cross-sectional profile in FIG. 12. The grooves were aligned in a circumferential direction and had repeat pitch of 770 micrometers, a trapezoidal cross-section shape, nominal depth of 25 micrometers, a nominal opening at main surface of face-side roller of 100 micrometers, and a nominal sidewall slope of 110 degrees as determined from horizontal direction across the bottom of the grooves.

### UV Curing Setup

Upon exiting the splitting station, the higher viscosity coatable material possessed a complex textured surface. The coated substrate was then directed into another station where it was cured with a Fusion UV Systems, H+ bulb in focus with aluminum reflectors. The coated substrate was supported by a water-cooled backup roll operated at 70° F. (21° C.) as it was transported through a nitrogen purged UV station containing less than 50 ppm oxygen. The result was a web release liner having a resultant complex textured surface that comprised an interconnected network of raised ridge features.

Regarding the complex textured surface of the cured coating layer and referring to FIG. 6, first area 650a is a textured region associated with splitting the coatable material between the major surface of the face-side roller and the substrate. Second area 655a is textured region associated with splitting the coatable material between a grove in the face-side roller and the substrate. The second area generally aligns with the groove direction in the face-side metal roller. A network of substantially interconnected ridges meanders through the first area and second area, and certain ridge formations, such as ridge 660a, extend between the first area and the second area.

FIG. 7a shows a particular area of the complex textured surface shown in FIG. 6, and FIG. 7b shows a profile of the cross-section of the particular area. Certain of the ridge features interconnect the first area, and certain of the ridge features interconnect the second area. Certain ridge features, such as ridge feature 660a, interconnect the first area 650 and the second area 655.

### Surface Topography

A WYKO NT1100 Surface Profiler (Bruker, Billerica, Mass.) was used to evaluate the surface topography. The ridge network, exemplified by area 655a, had ridges that were about 16 to 24 micrometers high and up to about 260 micrometers wide as determined at the base of the coating surface. The average surface roughness (Ra) of the overall surface that included both areas 650a and 655a was 3.5 micrometers, while the textured area 650a had a smaller surface roughness of 0.46 micrometers.

### Example 1B

The web release liner article having a cured coating layer with a complex textured surface was prepared as described in Example 1A. It was then coated with a pressure sensitive adhesive (PSA) solution which was prepared as described for “Adhesive Solution 1” in U.S. Pat. No. 5,296,277 and further modified with 16 parts per hundred parts solids of “Adhesive Solution 1” (based on a nominal solids content of 25% for the “Adhesive Solution 1”) of SYLVARES TP 2019 (a thermoplastic terpene phenolic resin having a high terpene level, available from Arizona Chemical, Jacksonville, Fla.) by using an 0.008 inch (0.2 mm) gap on a bar coater followed by oven drying at 79° C. for a minimum of 10 minutes. The exposed adhesive surface was then laminated using a roll laminator at room temperature to a 0.002 inch (0.051 mm) thick plasticized, white, flexible poly(vinyl chloride) (PVC) film.

The web article (liner) was cleanly removed from the PSA. A sample of the resulting PSA backed PVC film, measuring about 3 inches by 3 inches (7.6 cm by 7.6 cm), was adhered by hand onto a flat, smooth glass panel by pressing the PSA backed PVC film down along the outer edges of the film. Then pressure was applied to the film in a downward, circular motion that progressed to the center of the sample to remove any remaining entrapped air pockets. The white PVC film surface was visually inspected (by unaided eye) for any remaining bulges in the film surface caused by entrapped air pockets. No bulges were observed indicating good air egress.

### Comparative Example 1A

Comparative Example 1A was prepared as described in Example 1A with the following modifications. The nip at the face-side metal roller was open, so that the coating material was not contacted to the face-side roller. The cured coating material thus had a smooth, glossy, cured coating. The average surface roughness (Ra) was 0.063 micrometers overall.

### Comparative Example 1B

A PSA backed PVC film was prepared as described in Example 1 using the web article (liner) of Comparative Example 1A as a liner. The liner was cleanly removed from the PSA and the resulting PSA backed PVC film was applied and evaluated as described in Example 1B. Bulges were observed in the film surface indicating poor air egress resulting in entrapped air pockets.

### Example 2A

Example 1A was repeated with the following modifications. The gap setting was 0.005 inches (0.127 mm) and the flow rate was 70.0 grams/minute. The target dry thickness of the coatable material was 6 micrometers.

Referring to FIG. 8, first area 650b is a textured region associated with splitting the coatable material between the major surface of the face-side roller and the substrate. Second area 655b is a textured region associated with splitting the coatable material between a groove area of the face-side roller and the substrate.

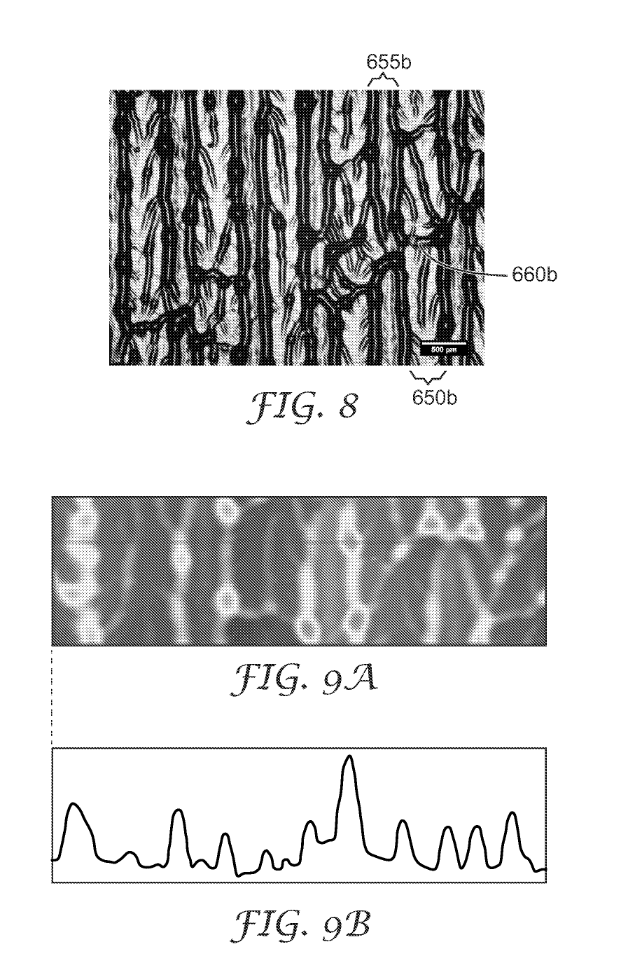

FIG. 9a shows a particular area of the complex textured surface of that shown in FIG. 8, and FIG. 9b shows a profile of the cross-section of the particular area. Certain of the ridge features interconnect the first area, and certain of the ridge features interconnect the second area. Certain of the ridge features, such as 660a, interconnect between the first and second area.

Surface topography was evaluated as described in Example 1A. The ridge network exemplified by area 655b had ridges that were in part double side by side component ridges. The ridges were about 9 to about 18 to 25 micrometers high. Each component ridge was about 95 to 125 micrometers wide and the overall combined ridge about 400 to 418 micrometers wide as determined at the base of the coating surface.

The average surface roughness (Ra) of the overall surface that included both areas 650b and 655b was 3.2 micrometers, while the textured area 650b between the ridge network had a smaller surface roughness of 0.47 micrometers.

### Example 2B

A PSA backed PVC film was prepared as described in Example 1B using the web article (liner) of Example 2A. The liner was cleanly removed from the PSA and the resulting PSA backed PVC film was applied and evaluated as described in Example 1B. No bulges were observed indicating good air egress. A peel tester Model SP-102B-3M90 available from Instrumentors Inc., Strongville, Ohio was used to measure the peel removal force of the film article from a sample of the pressure sensitive adhesive backed PVC film. The peel angle was 180 degrees and the peel rate was 90 inches/minute (229 cm/min.). A peel removal force of 1.8 ounces/inch (20.5 grams/cm) was recorded.

### Comparative Example 2A

Example 2A was repeated with the following modification. The nip at the face-side roller was left open, so that the coating material was not brought into contact with the face-side roller. A smooth, glossy cured coating was obtained. The average surface roughness (Ra) was 0.027 micrometers overall.

### Comparative Example 2B

A PSA backed PVC film was prepared from the web article (liner) of Comparative Example 2A and applied and evaluated as described in Example 1B. Bulges were observed in the film surface indicating poor air egress resulting in entrapped air pockets.

### Example 3

Example 1A was repeated with the following modifications. TEGOTMRAD 2700 was not included in the coatable material; the flow rate was 58.3 grams/minute; and the target dry thickness of the coatable material was 5 micrometers.

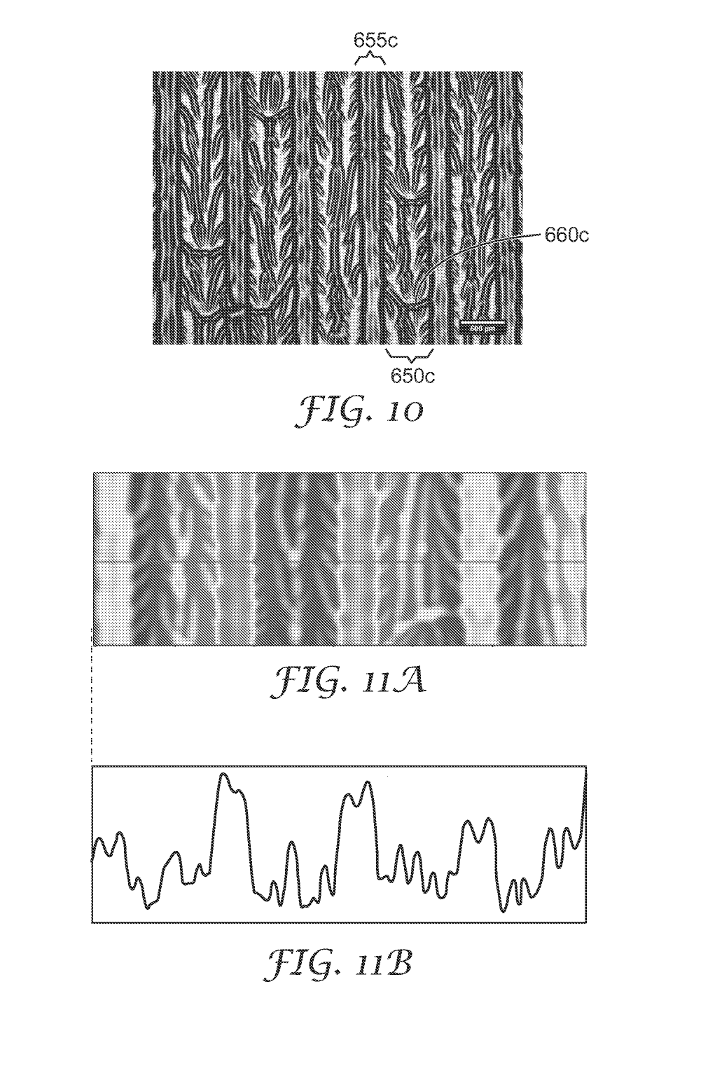

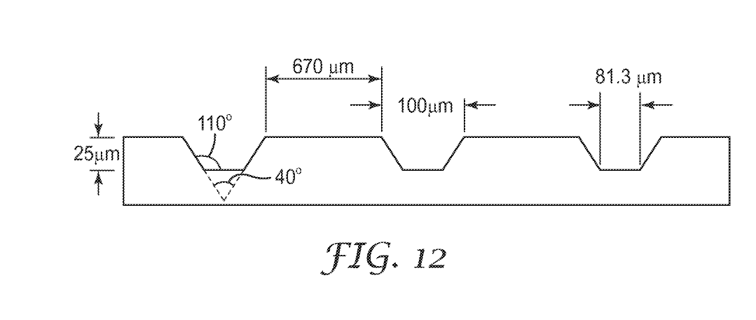

Referring to FIG. 10, first area 650c is a textured region associated with splitting the coatable material between the major surface of the face-side roller and the substrate. Second area 655c a second textured region associated with splitting the coatable material between a groove area of the face-side roller and the substrate. A network of ridge features may be seen interconnecting the first region. A network of ridge features may be seen interconnecting the second region. Certain of the ridge features, such as ridge feature 660c, extend between the first region and the second region.

FIG. 11a shows a particular area of the complex textured surface shown in FIG. 10, and FIG. 11b shows a profile of the cross-section of the particular area.

Surface topography was evaluated as described in Example 1A. The ridge network, exemplified by area 655c, had ridges that were in part double side-by-side component ridges. The ridges were about 10 to 11 micrometers high. The overall width of the combined ridges was about 320 micrometers. The average surface roughness (Ra) of the overall surface that included both areas 650c and 655c was 3.3 micrometers, while the textured area 650c between the ridge network had a smaller surface roughness of 0.17 micrometers and ridges that were about 4 to 5 micrometers high.

### Comparative Example 3

Example 3 was repeated with the following modification. The nip at the face-side roller was left open, so that the coating material was not brought into contact with the face-side roller. A smooth, glossy cured coating was obtained. The average surface roughness (Ra) was 0.098 micrometers overall. This was Example 3 with the nip left open.

### Example 4A

Example 1A was repeated with the following modifications. The gap setting was 0.004 inches (0.102 mm) and the flow rate was 48.6 grams/minute. The target dry thickness of the coatable material was 7 micrometers. A 9 inch wide by 0.005 inch thick (22.9 cm by 0.127 mm) clay coated C1S paper (from Boise Cascade, International Falls, Minn.) was used as the substrate in place of the primed polyester film. The coatable material was a mixture of 50.00% by wt. of methyl ethyl ketone, 32.92% by wt. of CN981B88 (an aliphatic polyurethane diacrylate, available from Arkema Sartomer, Exton, Pa.), 14.11% by wt. of SR444C (pentarythritol triacrylate, available from Arkema Sartomer, Exton, Pa.), 2.50% by wt. of KF-2001 (a thiol derivatized silicone, available from Shin-Etsu, Tokyo, Japan), and 0.47% by wt. of IRGACURE 819 (phenylbis(2,4,6-trimethylbenzoyl)-phosphine oxide, a photoinitiator, available from BASF Corporation, Florham Park, N.J.).

Surface topography was evaluated as described in Example 1A. The ridge network associated with the face-side roller's grooves had ridges that were in part double side by side component ridges. The ridges were about 6 to 7 micrometers high. The overall width of the combined ridges was about 356 micrometers.

The average surface roughness (Ra) of the overall surface that included both the ridge network and the texture area in between was 2.4 micrometers, while the textured area between the ridge network had a smaller surface roughness of 0.85 micrometers.

### Example 4B

A PSA backed PVC film was prepared as described in Example 1B using the liner of Example 4A. The liner was cleanly removed from the PSA and the resulting PSA backed PVC film was applied and evaluated as described in Example 1B. No bulges were observed indicating good air egress.

### Comparative Example 4A

Example 4A was repeated with the following modification. The nip at the face-side roller was left open, so that the coating material was not brought into contact with the face-side roller. A smooth, glossy cured coating was obtained. The average surface roughness (Ra) was 0.51 micrometers overall.

### Comparative Example 4B

A PSA backed PVC film was prepared as described in Example 1B using the web article (liner) of Comparative Example 4A. The PSA backed PVC film was cleanly removed from the PSA. The PSA backed PVC film was applied and evaluated as described in Example 1B. Bulges were observed in the film surface indicating poor air egress resulting in entrapped air pockets.

1. A method of producing a web with a complex topography comprising:
applying a first coatable material to a first major surface of a substrate;
changing the viscosity of the first coatable material from a first viscosity to a second viscosity to form a second coatable material;
contacting the second coatable material on the substrate to a face-side roller having a first major surface and a plurality of roll features set into the first major surface of the face-side roller;
splitting the second coatable material between the substrate and the face-side roller, to impart a resultant texture in the second coatable material on the substrate, wherein the resultant texture comprises a first area associated with splitting between the first major surface of the face-side roller and the substrate, and a second area resulting from splitting between an area on the face side roller associated with at least one of the roll features and the substrate, and wherein the resultant texture comprises an interconnected network of raised ridge features within at least the second area; and,
hardening the textured second coatable material to produce the web with an ensuant textured surface.

2. The method of claim 1, wherein the web comprises a liner.

3. The method of claim 1, wherein the resultant texture comprises an interconnected network of raised ridge features within both the first area and the second area.

4. The method of claim 1, wherein the interconnected network of raised ridge features includes branches that extend between the first and second areas.

5. The method of claim 3, wherein the interconnected network of raised ridge features includes branches that extend between the first and second areas.

6. The method of claim 4, wherein the roll features comprise an inset pattern, and wherein the raised ridge features substantially correspond to the inset pattern.

7. The method of claim 6, wherein the inset pattern comprises grooves inset into the outer surface of the face-side roller, and wherein the grooves have a position and a dimension relative to other grooves on the face side roller.

8-12. (canceled)

13. The method of claim 4, wherein the resultant texture comprises a first texture resultant from the splitting, and a second texture overlaid within the first texture that corresponds to the roll features.

14. (canceled)

15. The method of claim 4, wherein the first coatable material comprises a material that promotes release.

16-28. (canceled)

29. The method of claim 2, further comprising:
laminating the liner to a further web, the further web including a further substrate and an adhesive coating, and wherein laminating brings the adhesive coating into intimate contact with the ensuant textured surface.

30. The method of claim 4, further comprising:
contacting the ensuant textured surface with a formable material.

31-33. (canceled)

34. The method of claim 30, wherein the formable material comprises an organosol.

35-68. (canceled)

69. An article produced by contacting a formable material to a textured surface of a web, the web produced by a method comprising:
applying a first coatable material to a first major surface of a substrate;
changing the viscosity of the first coatable material from a first viscosity to a second viscosity to form a second coatable material;
contacting the second coatable material on the substrate to a face-side roller having a first major surface and a plurality of roll features set into the first major surface of the face-side roller;
splitting the second coatable material between the substrate and the face-side roller, to impart a resultant texture in the second coatable material on the substrate, wherein the resultant texture comprises a first area associated with splitting between the first major surface of the face-side roller and the substrate, and a second area resulting from splitting between an area on the face side roller associated with at least one of the roll features and the substrate, and wherein the resultant texture comprises an interconnected network of raised ridge features within at least the second area; and,
hardening the textured second coatable material to produce the web with an ensuant textured surface.

70. The article of claim 69, wherein the web is a release liner.

71. The article of claim 69, wherein the resultant texture comprises in interconnected network of raised ridge features within both the first area and the second area.

72-87. (canceled)

88. An article produced by contacting a formable material to a textured surface of a web, the web produced by a method comprising:
applying a first coatable material to a first major surface of a substrate;
changing the viscosity of the first coatable material from a first viscosity to a second viscosity to form a second coatable material;
contacting the second coatable material on the substrate to a face-side roller having a first major surface;
splitting the second coatable material between the substrate and the face-side roller, to impart a resultant texture in the second coatable material on the substrate, and,
hardening the textured second coatable material to produce the web with an ensuant textured surface.

89. The article of claim 88, wherein the web is a release liner.

90. The article of claim 88, wherein the formable material comprises an adhesive.

91-99. (canceled)
